(19) United States
(12) Patent Application Publication
(10) Pub. No.: US 2008/0109564 A1
(43) Pub. Date: May 8, 2008

(54) METHOD, SYSTEM, AND APPARATUS FOR ENHANCED MANAGEMENT OF MESSAGE SIGNALED INTERRUPTS

(76) Inventors: Richard L. Arndt, Austin, TX (US); Steven M. Thurber, Austin, TX (US); Maneesh Sharma, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/556,379

(22) Filed: Nov. 3, 2006

(51) Int. Cl. G06F 13/14

(52) U.S. Cl. 710/3

(57) ABSTRACT

A message signaled interrupt (MSI) specifying an input/output (I/O) address in I/O address space is received. In response to receipt of the MSI, a translation data structure is accessed and the I/O address is translated into a physical memory address by reference to the translation data structure. The MSI is then enqueued in an event queue at the physical memory address for subsequent servicing.

### BACKGROUND OF THE INVENTION

1. Technical Field

The present invention relates in general to data processing and in particular to interrupt management within a data processing system.

2. Description of the Related Art

Conventional computer systems include some mechanism for hardware and software components of the computer system, such as Input/Output (I/O) adapters, processors, and processes, to signal occurrences of events, which signaling often serves as a request for some time of service by a processor of the computer system. Originally, interrupts were commonly implemented as level-signaled interrupts, which were signaled to a processor through the assertion of dedicated hardware signal lines connected to the processor. However, as the potential interrupt sources and number of different interrupt events multiplied, the use of Level Signaled Interrupts (LSIs) became unwieldy, and interrupts became more frequently implemented as Message Signaled Interrupts (MSIs). For example, Peripheral Component Interface (PCI) Local Bus Specification, Revision 2.2 (Dec. 18, 1998) and later revisions of the PCI Local Bus Specification define a Message Signaled Interrupt (MSI) protocol, which facilitates the signaling of events to an interrupt controller in the form of event messages targeting particular address ranges. Subsequent enhancements, such as extended MSI (MSI-X) expand the original MSI protocol to allow a given interrupt source to source up to 2048 (i.e., 2K) interrupts contemporaneously.

Current high performance computer systems have numerous processors, hundreds or thousands of interrupt sources, and may support multiple concurrent operating system (OS) images. Through hardware virtualization, the multiple operating system images may share access to processors, I/O adapters and other system resources. In such high performance computer systems, the interrupt controller conventionally collects all of the MSIs from the various interrupt sources (e.g., I/O adapters) into a shared event queue from which the MSIs are then distributed to the various OS images for handling. This arrangement has a number of drawbacks.

First, each MSI destination requires a finite state machine within the interrupt controller to represent its interrupt processing state; thus, the reasonable number of destination ports that a platform can implement limits the scale of the virtualized I/O adapters. Second, the limited MSI destination ports are critical resources that must be shared by multiple I/O adapters and OS images. Consequently, platform code supporting the multiple OS images must parse the MSI messages enqueued to the shared event queue and redistribute each MSI message to the appropriate OS image. Third, the MSI destination ports have no ability to verify that a given interrupt source is authorized to transmit MSIs to that MSI destination port. As a result, the platform code must perform the processing necessary to verify the authority of the interrupt source to interrupt the OS image. Fourth, the platform code utilized to virtualize the MSI destination ports adds to the path length and latency of MSI processing.

### SUMMARY OF THE INVENTION

In view of the foregoing and other shortcomings in the prior art, the present invention provides improved methods, systems, and apparatus for interrupt management in a data processing system.

According to one embodiment, a message signaled interrupt (MSI) specifying an input/output (I/O) address in I/O address space is received. In response to receipt of the MSI, a translation data structure is accessed and the I/O address is translated into a physical memory address by reference to the translation data structure. The MSI is then enqueued in an event queue at the physical memory address for subsequent servicing.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of an exemplary data processing system in accordance with the present invention;

FIG. 2 illustrates an exemplary embodiment of a Translation Control Entry (TCE) in accordance with the present invention;

FIG. 3 depicts an exemplary set of event queues for a partition of a data processing system in accordance with the present invention; and

FIG. 4 is a high level logical flowchart of an exemplary method of handling Message Signaled Interrupts (MSIs) in accordance with the present invention.

### DETAILED DESCRIPTION OF AN ILLUSTRATIVE EMBODIMENT

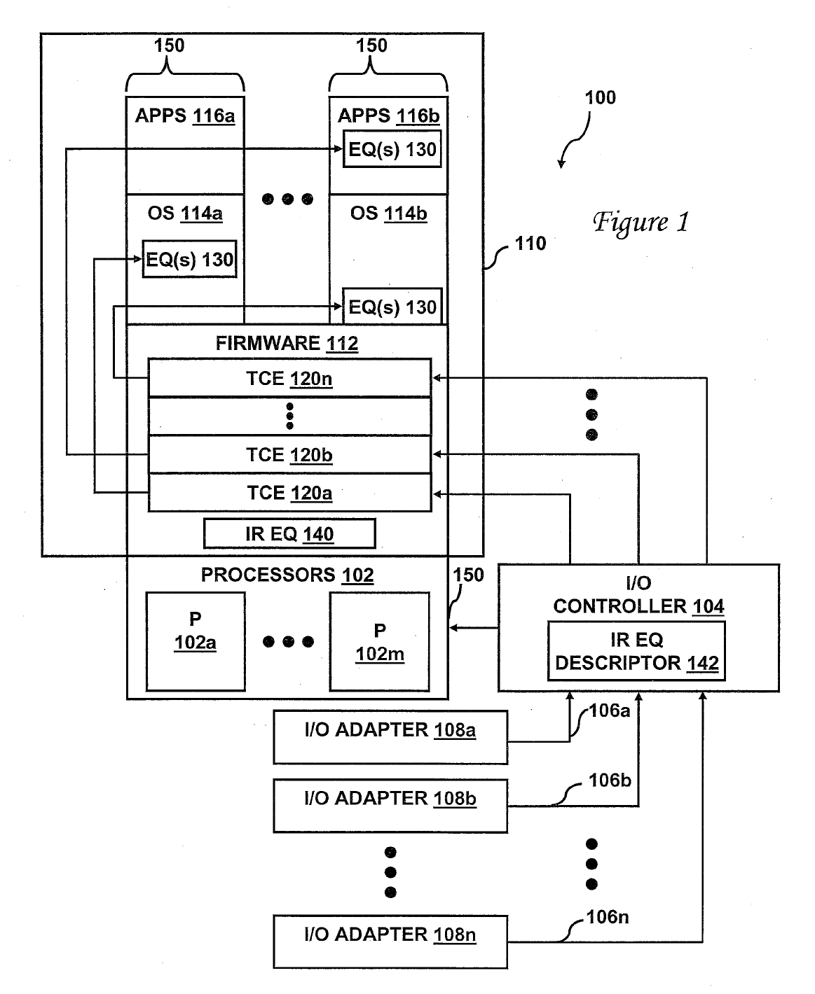

With reference now to FIG. 1, there is depicted a block diagram of an exemplary data processing system 100 in accordance with the present invention. As an example, data processing system 100 may be one of the IBM eServer System X or System P computer systems available from IBM Corporation of Armonk, N.Y.

As shown, data processing system 100 is a multiprocessor data processing system, which includes multiple processors 102, including processors 102a-102m, for processing program code including data and instructions. The program code processed by processors 102 is at least partially stored in data storage 110, which preferably includes non-volatile storage, such as hard disks and non-volatile random access memory (NVRAM), as well as volatile storage such as Dynamic Random Access Memory (DRAM). As will be appreciated, such program code typically resides in non-volatile storage and, when needed by processors 102, is paged into volatile storage.

Processors 102 are also coupled by one or more Level Signal Interrupt (LSI) lines 150 to an Input/Output (I/O) controller 104 that manages I/O operations in data processing system 100 including Direct Memory Access (DMA) operations and I/O interrupts, as discussed further below. I/O controller 104 is in turn coupled via I/O channels 106a-106n to a number of I/O adapters 108a-108n for interfacing I/O devices (not illustrated) with data processing system 100. During operation of data processing system 100, I/O adapters 108a-108n generate message signaled interrupts (MSIs), for example, in response to occurrence of an event related to an attached I/O device, and present the interrupts to I/O controller 104 for distribution. In one embodiment, at least some of I/O channels 106a-106n comprise I/O buses that conform to the PCI-X 2.0 local bus specification. In this embodiment, the MSIs generated by I/O adapters 108a-108n comprise MSI/MSI-X messages.

As further shown in data storage 110 of FIG. 1, the software environment of data processing system 100 includes firmware 112 (also referred to as a hypervisor) that supports the virtualization of the hardware resources of data processing system 100 (e.g., processors 102a-102m, I/O controller 104 and I/O adapters 108a-108n) and the logical partitioning of data processing system 100. Data processing system 100 is logically partitioned in that firmware 112 supports the independent execution by processors 102 of multiple concurrent and possibly heterogeneous operating systems (OSs) 114a-114b, which are each allocated a respective portion of volatile data storage 110 and which may further be allocated shared or exclusive access by firmware 112 to various virtualized hardware resources of data processing system 100, such as I/O controller 104 and I/O adapters 108a-108n. Each OS 114 may have one or more associated applications 116 running “on top” of the OS 114 and accessing its services and resources. An instance of an OS 114 and its associated applications 116 is referred to herein as a partition 150.

To support the virtualization of interrupt controllers (MSI destination ports) within I/O controller 104 described above, firmware 112 preferably implements one translation data structure, referred to herein as a Translation Control Entry (TCE) 120, for each virtualized interrupt controller. For example, in an embodiment in which firmware 112 presents I/O controller 104 to the partitions as N virtualized I/O controllers (where N is a positive integer), firmware 112 maintains within data storage 110 N TCEs 120a-120n. TCEs 120a-120n may be organized in a TCE table, as is well known in the art. As indicated in FIG. 1 and as discussed further below, the MSI interrupt controller within I/O controller 104 accesses TCEs 120a-120n to route MSIs generated by I/O adapters 108a-108n to particular Event Queues (EQs) 130 within the various partitions supported by firmware 112. The MSIs are then serviced by the various partitions from the EQs 130. MSIs that overflow EQs 130 are temporarily buffered by I/O controller 104 on an interrupt reject (IR) EQ 140, accessible via an IR EQ descriptor 142 within I/O controller 104.

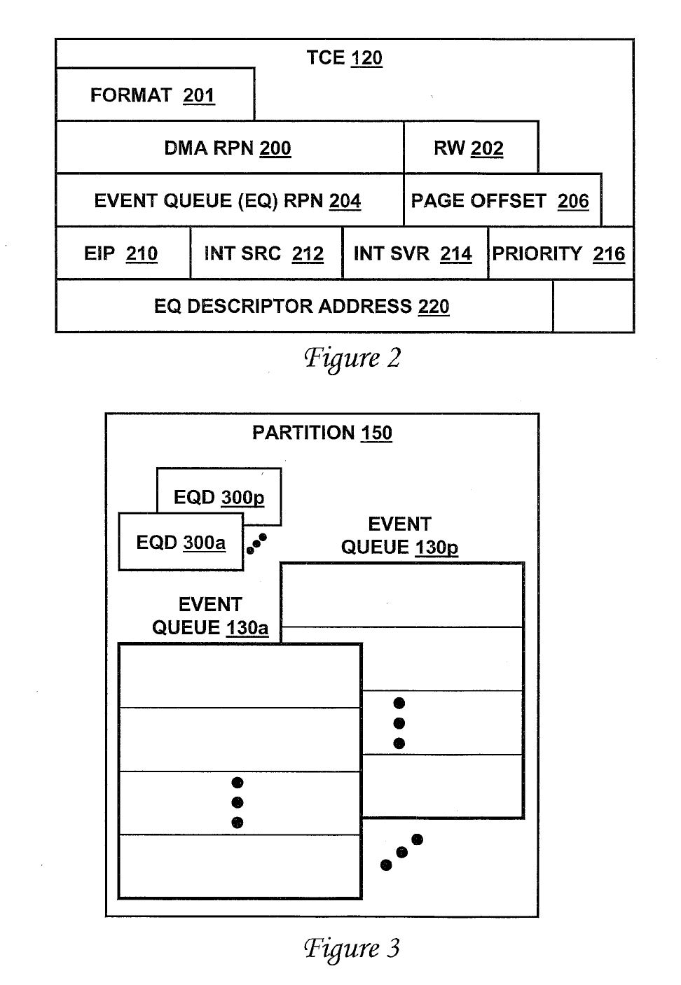

Referring now to FIG. 2, there is depicted a high level block diagram of an exemplary embodiment of a TCE 120 in accordance with the present invention. As illustrated, TCE 120 includes a number of fields utilized by I/O controller 104 to translate addresses within an I/O address space into physical memory addresses within data storage 110. The fields within TCE 120 include a Direct Memory Access (DMA) Real Page Number (RPN) field 200 that specifies the RPN of the portion of physical memory to which an I/O address of a DMA operation maps and a read/write field 202 indicating whether the DMA operation is permitted to read and/or write the physical memory. TCE 120 also includes an Event Queue (EQ) RPN field 204, which specifies the RPN of the portion of physical memory to which an I/O address of an MSI maps, and an associated page offset field 206, which indicates the offset of the EQ from the base address of the RPN.

TCE 120 further includes an Enqueue, Interrupt, Pending (EIP) field 210 containing flags indicating whether or not enqueuing of MSIs on the EQ 130 is currently enabled, whether or not interrupts are currently enabled for the EQ, and whether or not and interrupt is pending for the EQ. In addition, TCE 120 contains an interrupt source (INT SRC) field 212, and interrupt server (INT SVR) field 214, and a priority field 216 respectively identifying the interrupt source that is permitted to enqueue MSIs on the EQ 130, the interrupt server that will service the MSI, and the priority that will be accorded the MSI. TCE 120 further includes an EQ descriptor address field 220 that indicates the address of a descriptor for the EQ 130. The EQ descriptor indicates at least the EQ depth and a number of MSIs presently queued within the EQ 130.

Differing I/O address space addresses require different translations, and thus different combinations of the fields described above. Format bits 201 may be included within a TCE 120 to indicate whether the TCE 120 is for handling DMA requests or MSIs and to specify which fields are actually included in that TCE 120 in order to reduce the memory footprint of the TCE structure.

With reference now to FIG. 3, there is illustrated a more detailed block diagram of a partition 150 of data processing system 100 of FIG. 1. As indicated, each partition 150 may have one or more EQs 130a-130p within the physical memory space allocated to the OS 114 and/or application(s) 116 of that partition 150. Each EQ 130 has one or more entries for queuing MSIs and may be implemented utilizing any of a number of common data structures, such as a circular buffer.

Normally, each partition 150 will contain one EQ 130 for each respective I/O adapter 108 that has permission to send MSIs to that partition 150. However, depending upon the desired design, it is possible for multiple I/O adapters 108 to share an EQ 130 or one I/O adapter 108 to have multiple EQs 130 allocated within the same or different partition(s) 150.

As noted above with respect to FIG. 2, each of EQs 130a-130p has an associated EQ descriptor 300a-300p (normally located in the firmware) that provides additional information regarding the associated EQ 130. For example, each EQ descriptor 300 indicates (e.g., via pointers) a queue depth of the associated EQ 130 and the number a number of queue entries in which MSI are currently enqueued. The physical memory location of the EQ 130 is indicated by the EQ RPN field 204 of the TCE 120 for that EQ 130. When multiple interrupt sources share the same EQ 130, the EQ Descriptor Address 220 of the TCE 120 is used as an indirect pointer to the EQ descriptor 300 for the EQ 130 shared by the multiple interrupt sources.

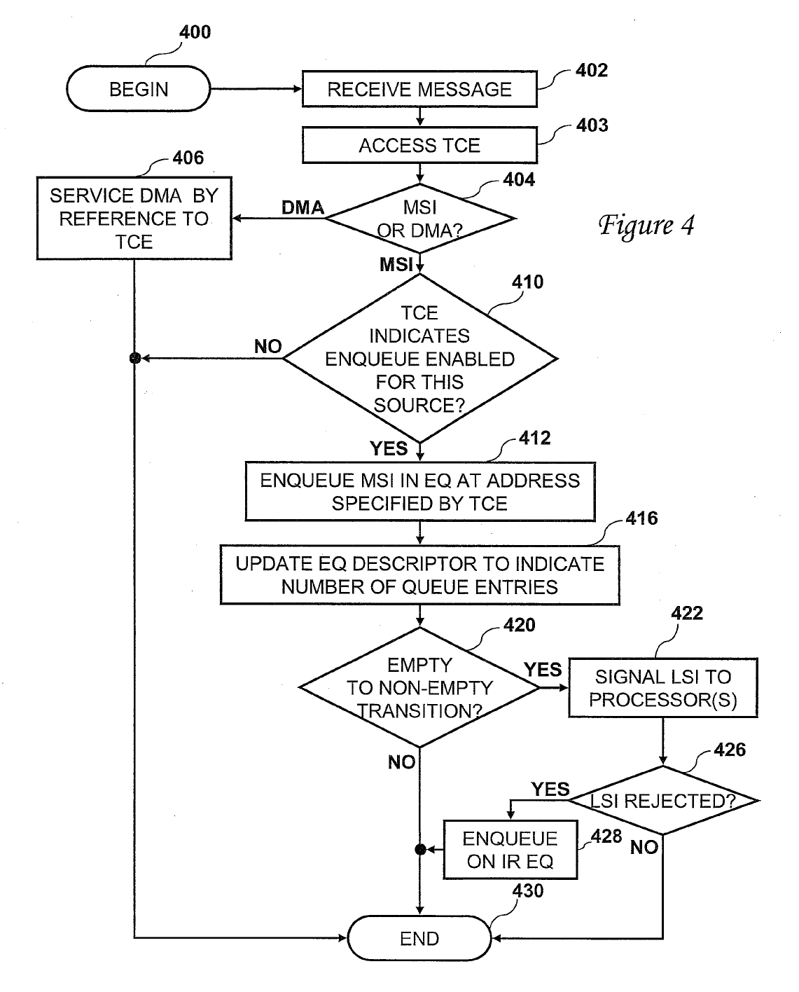

Referring now to FIG. 4, there is depicted a high level logical flowchart of an exemplary method by which I/O controller 104 handles MSIs in accordance with the present invention. Although preferably performed through the operation of hardware circuitry within I/O controller 104, those skilled in the art will appreciate that some or all of the depicted steps may alternatively or additionally be performed through the execution of program code by I/O controller 104.

The process begins at block 400 and then proceeds to block 402, which illustrates I/O controller 104 receiving an I/O message, which may be a DMA request or MSI, from one of I/O adapters 108. The I/O message contains, in addition to the message data, a target address in the I/O address space (which implies whether the I/O message is a DMA request or MSI), and an identifier of the interrupt source.

In response to receipt of the I/O message, I/O controller 104 utilizes the specified I/O address to access the appropriate one of TCEs 120 within data storage 110, as shown at block 403. In addition, I/O controller 104 determines at block 404 whether the I/O message is a DMA request or an MSI based upon the format bits 201 of the TCE 120 fetched at block 403. If I/O controller 104 determines that the I/O message is a DMA request, the process proceeds to block 406, which depicts I/O controller 104 servicing the DMA request by reference to the TCE 120 to which the I/O address maps. That is, I/O controller 104 permits or prevents the DMA read or DMA write specified by the DMA request to proceed based upon the read/write permissions indicated by read/write field 202 of the TCE 120. If the requested DMA access is permitted, I/O controller 104 translates the I/O address contained in the DMA request to a physical address by reference to the DMA RPN field 200 and forwards the DMA read or write request to physical memory within data storage 110. Thereafter, the process terminates at block 430.

Returning to block 404, if I/O controller 104 determines that the I/O message received at block 402 is an MSI, the process proceeds to block 410. Block 410 illustrates I/O controller 104 determining by reference to EIP field 210 of the TCE 120 whether or not interrupt enqueuing is enabled for the interrupt source identified in the MSI. If not, the process simply terminates at block 430 without queuing the MSI for servicing. Thus, the authorization of an interrupt source to send interrupts to a particular interrupt destination can be determined directly by reference to a TCE without firmware processing of enqueued MSIs.

Referring again to block 410, in response to I/O controller 104 determining that enqueuing is enabled for the specified interrupt source, I/O controller 412 then accesses the EQ descriptor 300, either as found in the TCE fetched in block 403 or indirectly by reference to the EQ descriptor address field 220 to determine the physical location of the EQ entry to fill in memory 110. The process then proceeds to block 412.

Block 412 depicts I/O controller 104 enqueuing the MSI on the EQ 130. Next, at block 416, I/O controller 104 updates the EQ descriptor 300 to indicate the current number of queue entries in EQ 130. I/O controller 104 then determines at block 420 whether or not enqueuing the MSI to the EQ 130 caused the EQ 130 to have an empty to non-empty transition. In response to a negative determination at block 420, the process terminates at block 430. If, on the other hand, I/O controller 104 determines at block 420 that enqueuing the MSI on EQ 130 caused the EQ 130 to make an empty to non-empty transition, I/O controller 104 asserts a Level Signaled Interrupt (LSI) to processors 102 via signal lines 150. Asserting the LSI causes the partitions 150 to access their respective EQs 130 and service MSIs queued therein. As an MSI is serviced by a partition 150, the partition 150 removes the MSI from the EQ 130 and updates the associated EQ descriptor 300 to indicate the removal of the entry. Following block 422, the process proceeds to block 426, which depicts a determination of whether the LSI was rejected by processors 102. If not, the process simply terminates at block 430. If, however, a determination is made at block 426 that processors 102 rejected the LSI, a message is enqueued on IR EQ 140 to trigger the software servicing of EQs 130 and the MSIs queued therein (block 428). Following block 428, the process terminates at block 430.

As has been described, the present invention provides an improved method, system and apparatus for handling MSIs utilizing a TCE address translation framework. The present invention supports an arbitrarily large number of MSI destination ports, each capable of verifying the authority of an interrupt source to post MSIs, thus allowing the destination EQs to be directly accessed by the targeted OS images without additional authorization processing (since unauthorized interrupt sources are prevented from posting MSIs). As a result, interrupt processing path length is significantly reduced as compared to conventional MSI handling, and hardware complexity is reduced by eliminating the need for hardware state machines to represent interrupt processing state.

While an illustrative embodiment of the present invention has been described in the context of a fully functional computer system with installed program code, those skilled in the art will appreciate that aspects of an illustrative embodiment of the present invention are capable of being distributed as a program product in a variety of forms, and that an illustrative embodiment of the present invention applies equally regardless of the particular type of computer readable media used to actually carry out the distribution of the program code. Examples of computer readable media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. A method of data processing in a data processing system, said method comprising:
receiving a message signaled interrupt (MSI) specifying an input/output (I/O) address in I/O address space;
in response to receipt of the MSI, accessing a translation data structure and translating the I/O address into a physical memory address by reference to the translation data structure; and
enqueuing the MSI in an event queue at the physical memory address for subsequent servicing.

2. The method of claim 1, and further comprising:
detecting whether said enqueuing caused an empty to non-empty transition for the event queue; and
in response to detecting that said enqueuing caused an empty to non-empty transition for the event queue, asserting a level signaled interrupt.

3. The method of claim 2, wherein:
said method further comprises accessing a descriptor of the event queue by reference to the translation data structure; and
said detecting comprises determining whether said event queue is empty by reference to said descriptor.

4. The method of claim 1, and further comprising:
in response to detecting an interrupt rejection, enqueuing a message in an interrupt reject event queue to signal subsequent processing of the event queue.

5. The method of claim 1, wherein said translation data structure comprises a first translation data structure, and said method further comprises servicing a direct memory access (DMA) request by reference to a second translation data structure.

6. The method of claim 1, and further comprising:
supporting a plurality of concurrently executing operating system images;
presenting an I/O controller as a plurality of virtual I/O controllers; and
implementing a respective one of a plurality of translation data structures for each of the plurality of virtual I/O controllers.

7. A data processing system, comprising:
one or more processors;
data storage coupled to the processor, the data storage including a plurality of translation data structures and a hypervisor executable by said one or more processors; and
an input/output (I/O) controller coupled to the processor and to the data storage, wherein said I/O controller, responsive to receiving a message signaled interrupt (MSI) specifying an I/O address in I/O address space, forwards said MSI to said hypervisor;
wherein said hypervisor accesses a translation data structure among the plurality of translation data structures, translates the I/O address into a physical memory address by reference to the translation data structure, and enqueues the MSI in an event queue at the physical memory address for subsequent servicing.

8. The data processing system of claim 7, wherein said hypervisor detects whether enqueuing the MSI caused an empty to non-empty transition for the event queue and, responsive to detecting that enqueuing the MSI caused an empty to non-empty transition for the event queue, asserts a level signaled interrupt to the one or more processors.

9. The data processing system of claim 8, wherein:
the data storage includes a descriptor of the event queue;
the hypervisor accesses a descriptor of the event queue by reference to the translation data structure and detects whether said event queue is empty by reference to said descriptor.

10. The data processing system of claim 7, wherein:
said data storage includes an interrupt reject event queue; and
said hypervisor, responsive to detecting an interrupt rejection, enqueues a message in the interrupt reject event queue to signal subsequent processing of the event queue.

11. The data processing system of claim 7, wherein:
said translation data structure comprises a first translation data structure;
said plurality of translation data structures includes a second translation data structure; and
said hypervisor services a direct memory access (DMA) request received from the I/O controller by reference to the second translation data structure.

12. The data processing system of claim 7, and further comprising:
a plurality of concurrently executing operating system images within said data storage;
wherein the hypervisor presents the I/O controller to the plurality of operating system images as a plurality of virtual I/O controllers and implements a respective one of the plurality of translation data structures for each of the plurality of virtual I/O controllers.

13. A program product, comprising:
a tangible computer readable medium; and
program code within said tangible computer readable medium, wherein said program code causes a data processing system to perform a method including the following steps:
receiving a message signaled interrupt (MSI) specifying an input/output (I/O) address in I/O address space;
in response to receipt of the MSI, accessing a translation data structure and translating the I/O address into a physical memory address by reference to the translation data structure; and
enqueuing the MSI in an event queue at the physical memory address for subsequent servicing.

14. The program product of claim 13, wherein said program code detects whether enqueuing the MSI caused an empty to non-empty transition for the event queue and, responsive to detecting that enqueuing the MSI caused an empty to non-empty transition for the event queue, asserts a level signaled interrupt to the one or more processors.

15. The program product of claim 14, wherein:
the program code accesses a descriptor of the event queue by reference to the translation data structure and detects whether said event queue is empty by reference to said descriptor.

16. The program product of claim 13, wherein:
said program code, responsive to detecting an interrupt rejection, enqueues a message in the interrupt reject event queue to signal subsequent processing of the event queue.

17. The program product of claim 13, wherein:
said translation data structure comprises a first translation data structure;
said plurality of translation data structures includes a second translation data structure; and
said program code services a direct memory access (DMA) request received from the I/O controller by reference to the second translation data structure.

18. The program product of claim 13, wherein the program code presents an I/O controller to a plurality of concurrently executing operating system images as a plurality of virtual I/O controllers and implements a respective one of the plurality of translation data structures for each of the plurality of virtual I/O controllers.
